(19) United States
(12) Patent Application Publication
(10) Pub. No.: US 2009/0265413 A1
(43) Pub. Date: Oct. 22, 2009

(54) COMMUNICATION APPARATUS, COMMUNICATION METHOD, FLOW CONTROL APPARATUS, CONTROL METHOD, AND COMPUTER PROGRAM

(75) Inventors: Tetsuya Katsuragi, Kawasaki-shi (JP); Osamu Sasaki, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/097,745

(22) PCT Filed: Aug. 27, 2007
(86) PCT No.: PCT/JP2007/066569

§ 371 Date: Jun. 16, 2008

(30) Foreign Application Priority Data
Sep. 1, 2006 (JP) 2006-238171
Jul. 26, 2007 (JP) 2007-194795

(51) Int. Cl. G06F 15/16

(52) U.S. Cl. 709/201; 709/250

(57) ABSTRACT

An apparatus (102) receives a request (S101) from an apparatus (901), and transmits information (WSDL) describing an interface of a data transmission service in response to the request (S101). The apparatus (102) receives a request (S104) from an apparatus (103), and transmits data by the data transmission service in response to the request (S104), according to the interface of the service, received from the apparatus (103).

### TECHNICAL FIELD

The present invention relates to a communication apparatus, a communication method, a flow control apparatus, a control method, and a computer program.

### BACKGROUND ART

Conventionally, a “Web service” has been put into practical use, by which a plurality of apparatuses connected to a network transmit/receive data between them in cooperation with each other. In a flow control system using a message exchange scheme such as the Web service, messages and data are transmitted/received via a flow controller which interprets and executes a document describing a flow (see, e.g., patent reference 1).

Patent Reference 1: Japanese Patent Laid-Open No. 2004-361993

### DISCLOSURE OF INVENTION

### Problems that the Invention is to Solve

In the above described flow control system using message exchange via a flow controller, however, when a large amount of data such as image data are transferred between apparatuses, the following problems arise. Since data unnecessary for interpretation and use by the flow controller are transferred via the flow controller, additional resources of an apparatus functioning as the flow controller are required for the transfer, thus increasing the cost. Furthermore, the data transfer time increases because of the transfer via the flow controller.

It is an object of the present invention to decrease the cost or time for data transmission/reception between transmitting and receiving apparatuses.

### Means of Solving the Problems

According to the present invention, there is provided a communication apparatus which provides a data transmission service, characterized by comprising reception means for receiving a first request from a first apparatus and receiving a second request from a second apparatus, and transmission means for transmitting information describing an interface of the service in response to the first request received from the first apparatus and transmitting data by the service in response to the second request, according to the interface of the service, received from the second apparatus.

According to the present invention, there is also provided a flow control apparatus which controls an apparatus cooperative flow, characterized by comprising communication means for transmitting, to a first apparatus which provides a data transmission service, a first request to acquire information describing an interface of the service, and receiving the information describing the interface of the service, and transmission means for transmitting, to a second apparatus, a second request containing the information describing the interface of the service so that the second apparatus receives data using the service provided by the first apparatus.

According to the present invention, there is further provided a communication apparatus which receives data from another apparatus, characterized by comprising reception means for receiving information describing an interface of a data transmission service executed by the other apparatus from a flow control apparatus which controls an apparatus cooperative flow, and communication means for transmitting a data request to the other apparatus in accordance with the interface of the service, and receiving data transmitted by the other apparatus.

Other features and advantages of the present invention will be apparent from the following description taken in conjunction with the accompanying drawings. Note that the same reference numerals denote the same or similar configuration throughout the accompanying drawings.

### BRIEF DESCRIPTION OF DRAWINGS

The accompanying drawings, which are incorporated in and constitute a part of the specification, illustrate embodiments of the invention and, together with the description, serve to explain the principles of the invention.

FIG. 1 is a view showing an example of the configuration and operation of a flow control system according to the first embodiment;

FIG. 2 is a view showing a sequence of messages and data transmitted/received between apparatuses shown in FIG. 1;

FIG. 3 is a flowchart showing the internal operation of a flow control apparatus 101 shown in FIG. 1;

FIG. 4 is a flowchart showing the internal operation of a data transmitting apparatus 102 shown in FIG. 1;

FIG. 5 is a flowchart showing the internal operation of a data receiving apparatus 103 shown in FIG. 1;

FIG. 6A is a view showing an example of an interface description document provided by the data transmitting apparatus 101 and a data transmitting apparatus 901;

FIG. 6B is a view showing the example of the interface description document provided by the data transmitting apparatus 101 and the data transmitting apparatus 901;

FIG. 7A is a view showing an example of a data transmission preparation completion notification message (S102) containing the interface description document shown in FIGS. 6A and 6B;

FIG. 7B is a view showing the example of the data transmission preparation completion notification message (S102) containing the interface description document shown in FIGS. 6A and 6B;

FIG. 8A is a view showing an example of a data reception start request message (S103 or S902) containing the interface description document shown in FIGS. 6A and 6B;

FIG. 8B is a view showing the example of the data reception start request message (S103 or S902) containing the interface description document shown in FIGS. 6A and 6B;

FIG. 9 is a view showing an example of the configuration and operation of a flow control system according to the second embodiment;

FIG. 10 is a view showing a sequence of messages and data transmitted/received between apparatuses shown in FIG. 9;

FIG. 11 is a flowchart showing the internal operation of a data transmitting apparatus 902 shown in FIG. 9;

FIG. 12 is a flowchart showing the internal operation of a data receiving apparatus 903 shown in FIG. 9;

FIG. 13 is a block diagram showing the configuration of an apparatus;

FIG. 14 is a view showing an example of the configuration and operation of a system according to the second embodiment; and

FIG. 15 is a view showing an example of the configuration and operation of a system according to the third embodiment.

### BEST MODE FOR CARRYING OUT THE INVENTION

Preferred embodiments of the present invention will be described in detail with reference to the accompanying drawings.

### First Embodiment

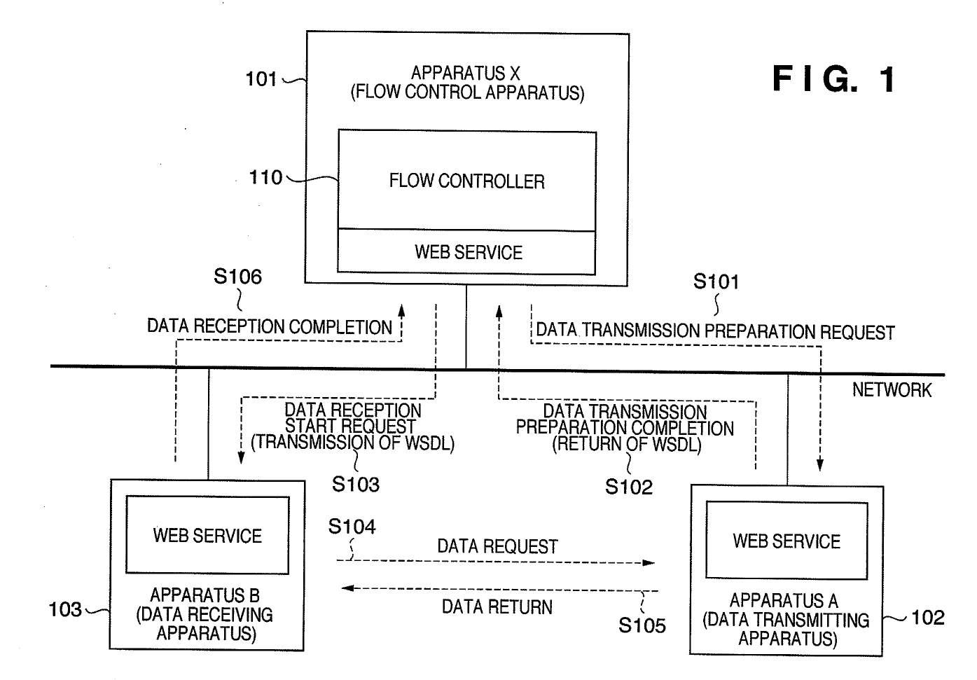

FIG. 1 is a view showing an example of the configuration and operation of a flow control system according to the first embodiment. Referring to FIG. 1, reference numeral 101 denotes apparatus X (a flow control apparatus), which has a function of interpreting a flow description document and controlling, by message exchange of a Web service, other apparatuses each connected to a network. Reference numeral 102 denotes apparatus A (a data transmitting apparatus), which has a function of transmitting data in response to requests from other apparatuses and that of providing, by the Web service, a document (to be referred to as an interface description document hereinafter) that describes an interface for transmitting the data. Reference numeral 103 denotes apparatus B (a data receiving apparatus), which has a function of receiving the interface description document by the Web service and that of interpreting the received interface description document to acquire data.

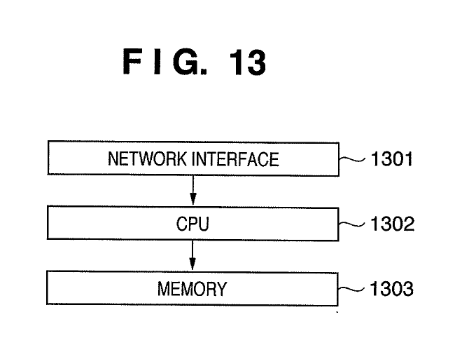

FIG. 13 is a block diagram showing a configuration example of the apparatus 101, 102, or 103. Referring to FIG. 13, reference numeral 1301 denotes a network interface for connecting the network; 1302, a CPU using a computer; and 1303, a memory for storing computer programs and control data. The CPU 1302 reads out the computer programs stored in the memory 1303, and controls the apparatuses 101, 102, and 103 to operate as follows.

Each of the above-described apparatuses is connectable to the network, and operates as a user or provider of the Web service. The flow control apparatus 101 includes a flow controller 110. The flow controller 110 interprets the flow description document, and executes control (to be described later in detail).

The control when the flow control apparatus 101 causes the data transmitting apparatus 102 to directly transmit the data to the data receiving apparatus 103 in the flow control system according to the first embodiment will be described now with reference to FIGS. 1 to 8B.

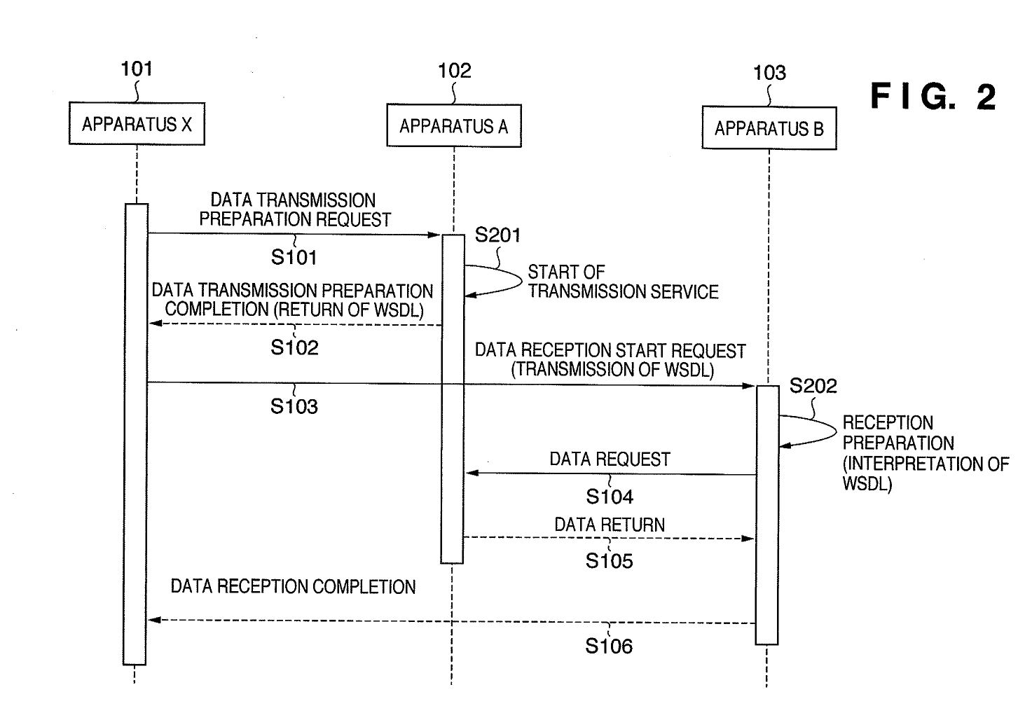

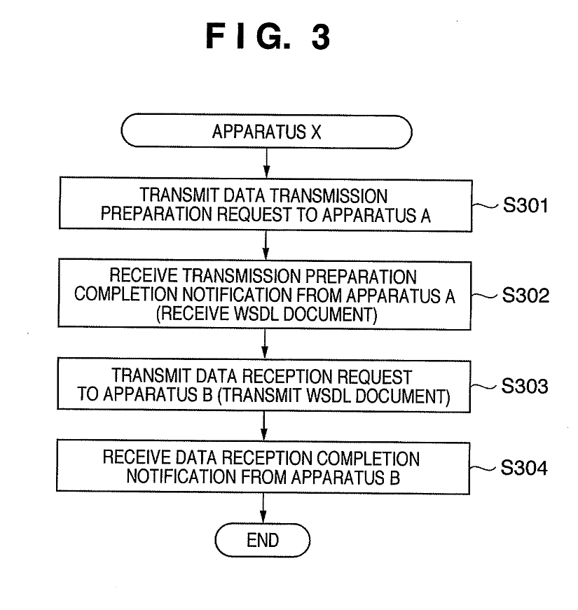

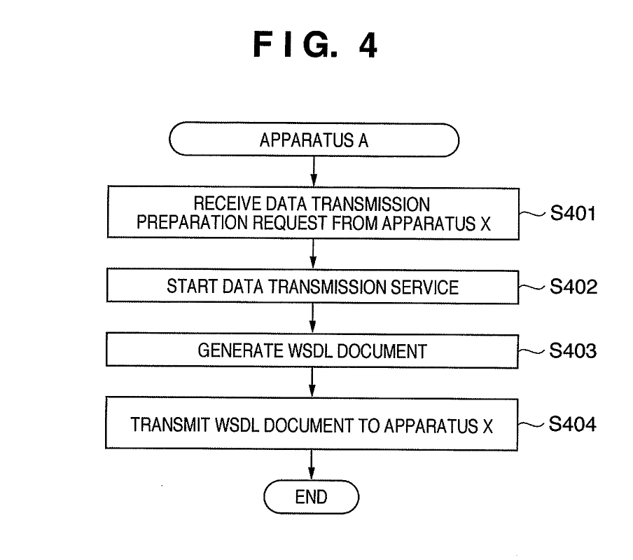

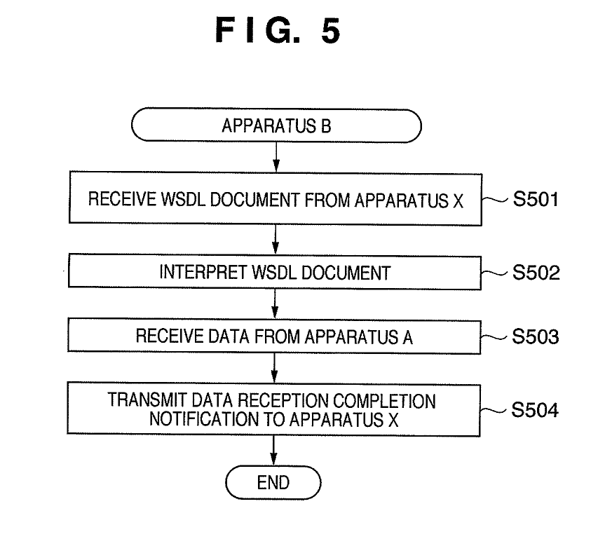

FIG. 2 is a view showing a sequence of messages and data transmitted/received between the apparatuses shown in FIG. 1. FIG. 3 is a flowchart showing the internal operation of the flow control apparatus 101 shown in FIG. 1. FIG. 4 is a flowchart showing the internal operation of the data transmitting apparatus 102 shown in FIG. 1. FIG. 5 is a flowchart showing the internal operation of the data receiving apparatus 103 shown in FIG. 1. The internal operations shown in FIGS. 3 to 5 are merely examples, and the present invention is not limited to them.

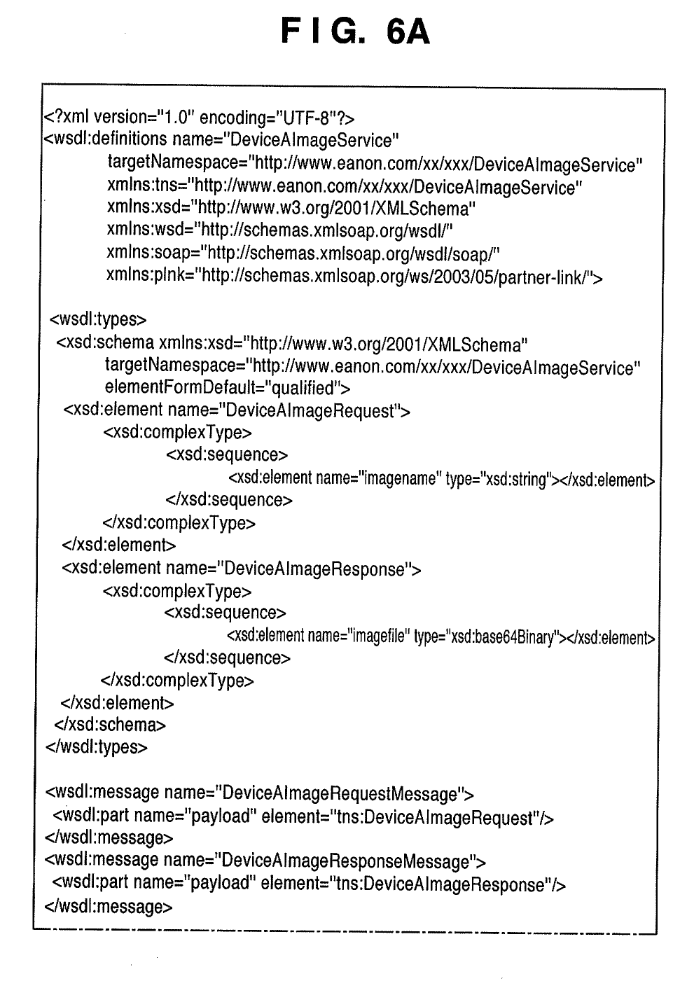

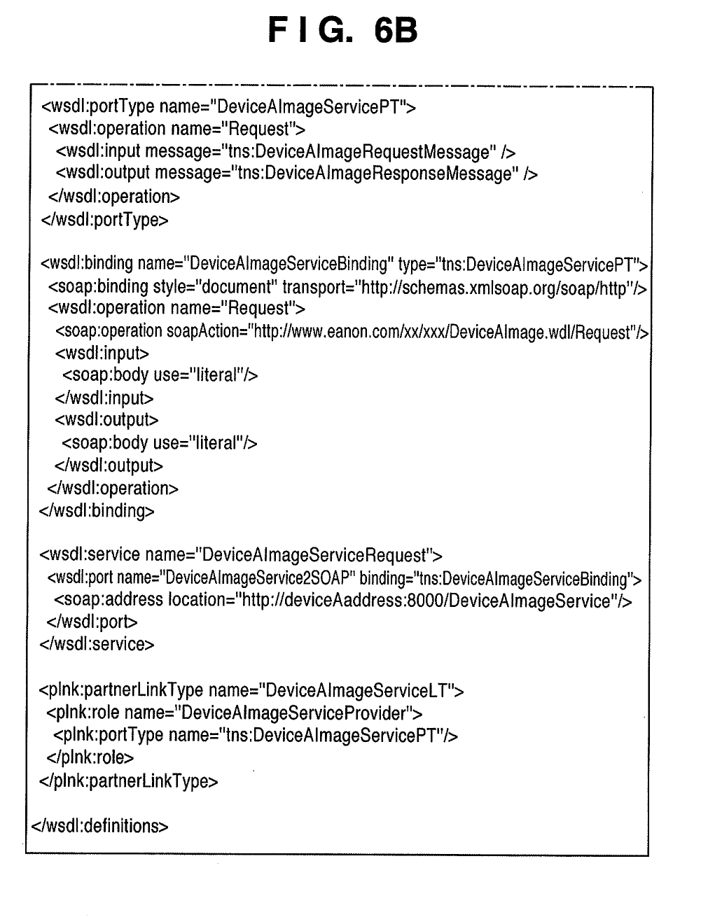

FIGS. 6A and 6B are views showing an example of the interface description document provided by the data transmitting apparatus 102. In FIGS. 6A and 6B, the example represents a document describing an interface of the Web service in WSDL. Note that WSDL is an abbreviation for Web Service Description Language, and is written in an XML format. This WSDL document contains wsdl:definitions, wsdl:types, wsdl:message, wsdl:portType, wsdl:binding, and wsdl:services elements.

In step S301 shown in FIG. 3, the flow control apparatus 101 transmits, to the data transmitting apparatus 102, a data transmission preparation request message (S101) to request preparation for data transmission using the Web service. The data transmission preparation request message (S101) contains a character string (identifier) representing a file (data) to be transmitted by the data transmitting apparatus 102. If the identifier is known to the data transmitting apparatus 102, the data transmission preparation request message (S101) need not contain the identifier.

Upon reception of the data transmission preparation request message (S101) from the flow control apparatus 101 in step S401 shown in FIG. 4, the data transmitting apparatus 102 starts a transmission service (S201) in step S402. In step S403, the data transmitting apparatus 102 generates an interface description document (FIGS. 6A and 6B) describing an interface of the started transmission service. In step S404, the data transmitting apparatus 102 returns a data transmission preparation completion notification message (S102) containing the interface description document to the flow control apparatus 101.

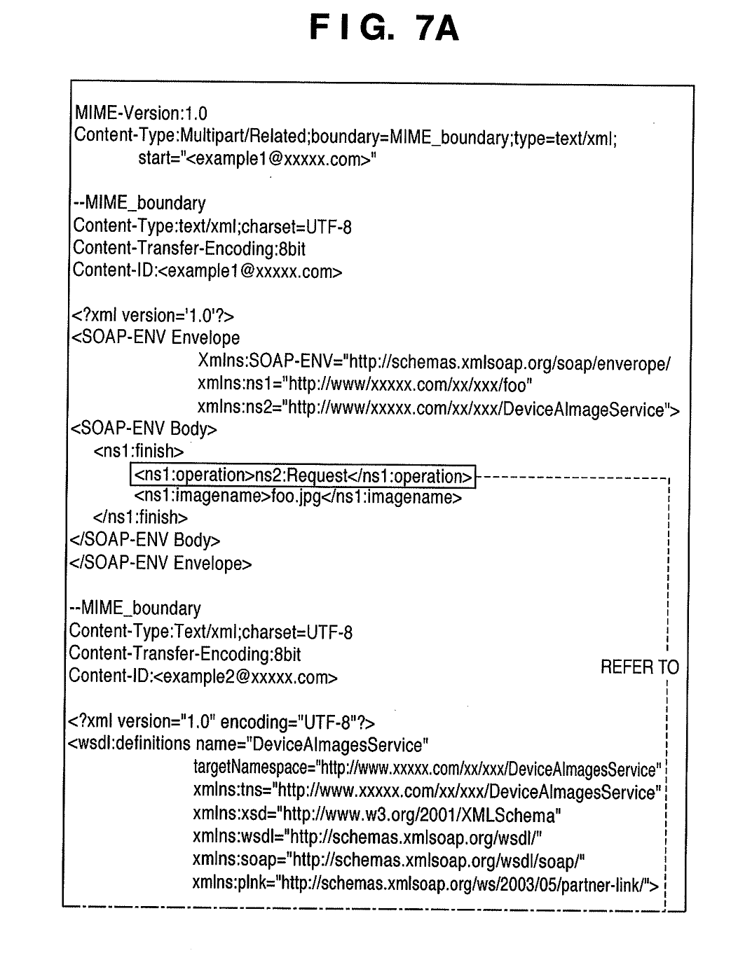

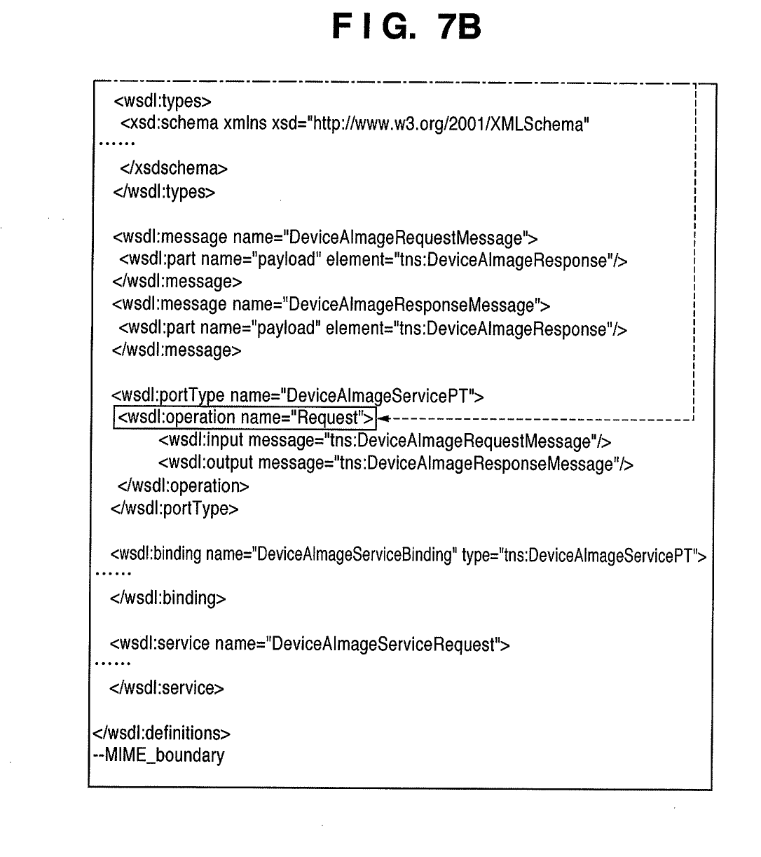

FIGS. 7A and 7B are views showing an example of the data transmission preparation completion notification message (S102) containing the interface description document (FIGS. 6A and 6B) to be transmitted from the data transmitting apparatus 102 to the flow control apparatus 101 in step S404. The example shown in FIGS. 7A and 7B shows a SOAP message to be transmitted by the Web service. The WSDL document as the interface document (FIGS. 6A and 6B) is attached to the SOAP message (S102) complying with the SOAP with Attachment specification. Although, in the example shown in FIGS. 7A and 7B, the message contains the WSDL document by attaching it, the method of containing the WSDL document in the SOAP message is not limited to this. A method of directly containing the WSDL document in a SOAP Envelope element is also available. SOAP is an abbreviation for Simple Object Access Protocol.

As shown in FIGS. 7A and 7B, the data transmission preparation completion notification message (S102) contains, in a SOAP Envelope element, an ns1:finish element representing that the message is the data transmission preparation completion notification message (S102). The ns1:finish element contains an ns1:operation element. The value of the ns1:operation element refers to, as QName, the value of a name attribute of a wsdl:operation element of the wsdl:portType element described in the attached WSDL document. This is shown in FIGS. 7A and 7B.

Note that the value of the name attribute uniquely specifies the wsdl:operation element. The wsdl:operation element of the wsdl:portType element represents operation in the Web service. That is, the wsdl:operation element indicated by QName as the value of the ns1:operation element represents the wsdl:operation element to be invoked by the data receiving apparatus 103 when the data transmitting apparatus 102 transmits data via the Web service. An interface description document indicated by the wsdl:operation element within the interface description document specified by the value of the ns1:operation element defines the format of the message to be transmitted from the data receiving apparatus 103 to the data transmitting apparatus 102.

A character string as the value of an ns1:imagefile element of the ns1:finish element represents a file to be transmitted by the data transmitting apparatus 102.

In step S302, the flow control apparatus 101 receives the data transmission preparation completion notification message (S102) containing the interface description document from the data transmitting apparatus 102. In step S303, the flow control apparatus 101 contains the interface description document received from the data transmitting apparatus 102 in a data reception start request message (S103), and transmits the message to the data receiving apparatus 103.

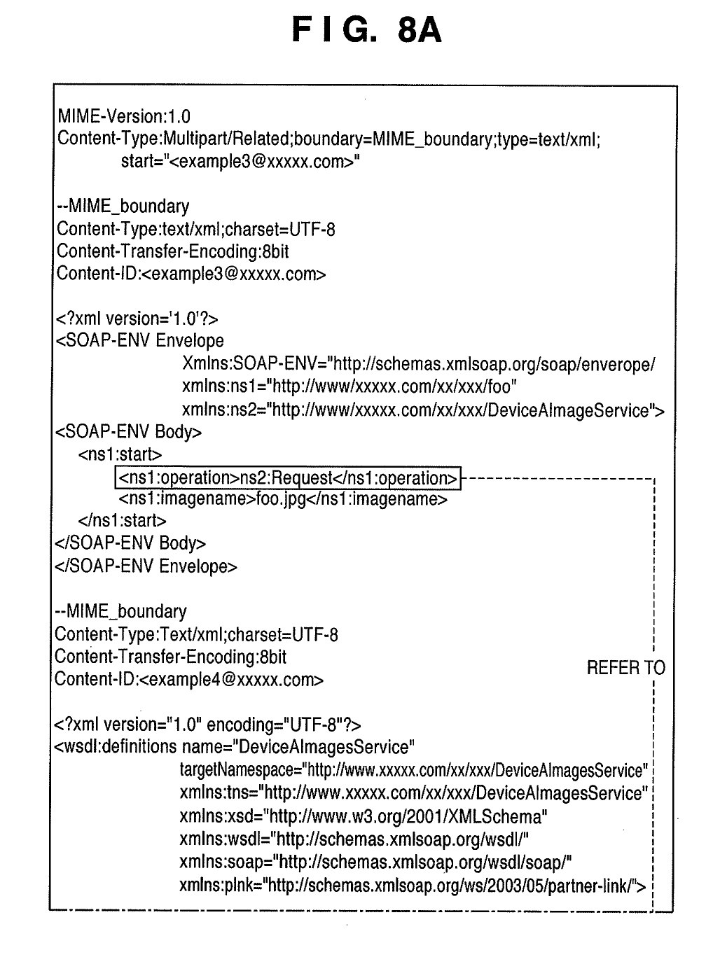

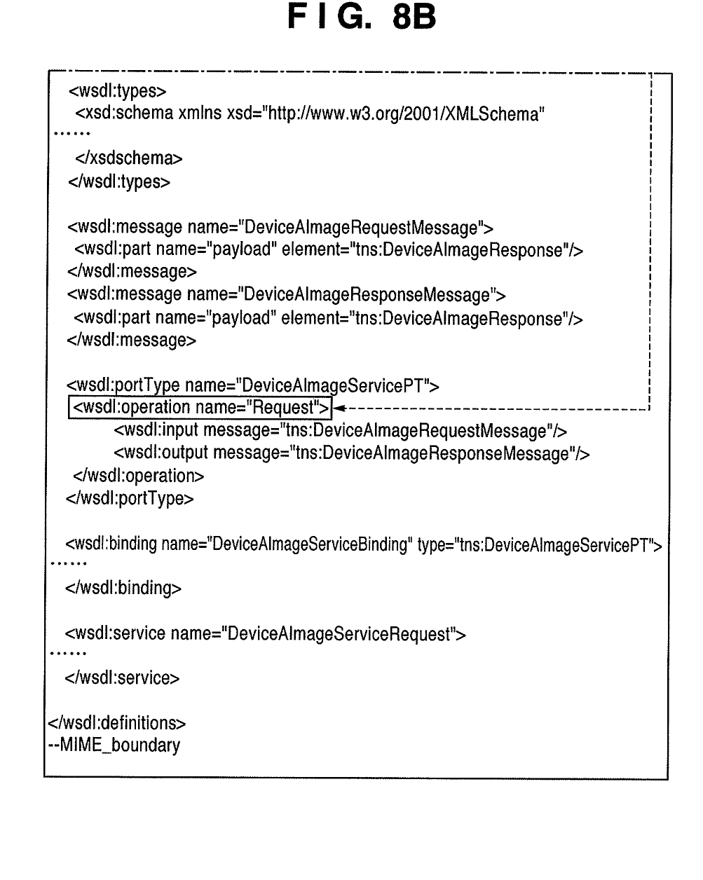

FIGS. 8A and 8B are views showing an example of the data reception start request message (S103) containing the interface description document (FIGS. 6A and 6B) to be transmitted from the flow control apparatus 101 to the data receiving apparatus 103 in step S302. In the example shown in FIGS. 8A and 8B, the WSDL document is attached complying the SOAP with Attachment specification similarly to the example shown in FIGS. 7A and 7B. The method of containing the WSDL document in the SOAP message, however, is not limited to this.

As shown in FIGS. 8A and 8B, the data reception start request message (S103) contains, in a SOAP Envelope element, an ns1:start element representing that the message is the data reception start request message (S103). The ns1:start element contains an ns1:operation element. The ns1:operation element refers to the value of a name attribute of a wsdl:operation element of the wsdl:portType element described within the attached WSDL document. The wsdl:operation element indicated by the value of the ns1:operation element represents the wsdl:operation element to be invoked by the data transmitting apparatus 102 when the data receiving apparatus 103 receives the data via the Web service. A character string as the value of an ns1:imagefile element represents a file for which the data receiving apparatus 103 should output a transmission request to the data transmitting apparatus 102.

In step S501 shown in FIG. 5, the data receiving apparatus 103 recognizes that the received message is the data reception start request message (S103), by reading the ns1:start element within the message received from the flow control apparatus 101.

When the data receiving apparatus 103 recognizes that the received message is the data reception start request message (S103), the data receiving apparatus 103 prepares for reception (S202) in step S502. In this example, the data receiving apparatus 103 interprets the contents of the ns1:start element, and acquires the value of the ns1:operation element of the ns1:start element. The data receiving apparatus 103 also interprets the interface description document contained in the data reception start request message (S103). In step S503, based on the interpretation result, the data receiving apparatus 103 creates a data request message (S104) in the format described in the interface description document indicated by the wsdl:operation element specified by the value of the ns1:operation element. At this time, the data receiving apparatus 103 reads a character string as the value of an ns1:imagename element described in the data reception start request message (S103). The data receiving apparatus 103 sets the character string acquired from the ns1:imagename element into the data request message (S104), and transmits the message to the data transmitting apparatus 102.

That is, the format of the data request message (S104) is defined in the interface description document indicated by the wsdl:operation element within the interface description document specified by the value of the ns1:operation element. The data receiving apparatus 103 sets, at a predetermined position of the message (S104) formed in the format, an identifier of data to be acquired. Upon reception of a data return message (S105) from the data transmitting apparatus 102, the data receiving apparatus 103 returns a data reception completion notification message (S106) to the flow control apparatus 101.

In this way, the data transmitting apparatus 102 serves as a communication apparatus which provides a data transmission service. The data transmitting apparatus 102 receives the first request (S101) from the flow control apparatus 101, and transmits information (WSDL) (S102) describing an interface of the service in response to the first request (S101). In this embodiment, the data transmitting apparatus 102 transmits the information (S102) to the flow control apparatus 101. Furthermore, the data transmitting apparatus 102 receives the second request (S104) from the data receiving apparatus 103, and transmits data (S104) by the data transmission service in response to the second request (S104), according to the interface of the service, received from the data receiving apparatus 103. The information describing the interface specifies the format of the second request (S104). The second request in the format contains, at a predetermined position, information specifying data. According to another embodiment, the information specifying the data is contained in the first request (S101) or the information (S102) describing the interface.

The data transmitting apparatus 102 is a communication apparatus which receives the first request (S101) from the flow control apparatus 101 controlling an apparatus cooperative flow, and transmits data in response to the second request (S104) from another apparatus connected to the network. That is, the data transmitting apparatus 102 has the first communication means for receiving the first request (S101) from the flow control apparatus 101, and transmitting the message (S102) containing the interface description document pertaining to the interface of the data transmission service. The data transmitting apparatus 102 also has the second communication means for receiving the second request (S104) corresponding to the interface description document from the data receiving apparatus 103, and transmitting the data (S105).

In this embodiment, the data transmitting apparatus 102 transmits the message (S102) to the flow control apparatus 101. The interface description document specifies the format of the second request (S104). The second request in the format contains, at a predetermined position, information specifying data. According to another embodiment, the information specifying the data is contained in the first request (S101) or the message (S102).

The flow control apparatus 101 controls an apparatus cooperative flow. The flow control apparatus 101 transmits, to the data transmitting apparatus 102 which provides the data transmission service, the first request (S101) to acquire the information describing the interface of the service. The flow control apparatus 101 receives the information (WSDL) (S102) describing the interface of the service from the data transmitting apparatus 102. The flow control apparatus 101 transmits, to the data receiving apparatus 103, the second request (S103) containing the information which describes the interface so that the data receiving apparatus 103 receives the data using the service provided by the data transmitting apparatus 102.

The flow control apparatus 101 controls an apparatus cooperative flow. The flow control apparatus 101 transmits the second request to the data transmitting apparatus 102 which transmits the data in response to the first request from another apparatus connected to the network. The flow control apparatus 101 receives the first message (S102) containing the interface description document pertaining to the interface of the data transmission service executed by the data transmitting apparatus 102. The flow control apparatus 101 transmits the second message (S103) containing the interface description document to the data receiving apparatus 103 so that the data receiving apparatus 103 receives the data from the data transmitting apparatus 102.

The data receiving apparatus 103 is a communication apparatus which receives the data from another apparatus. The data receiving apparatus 103 receives, from the flow control apparatus 101 which controls an apparatus cooperative flow, the information (S103) describing the interface of the data transmission service executed by the data transmitting apparatus 102. The data receiving apparatus 103 transmits the data request (S104) to the data transmitting apparatus 102 in accordance with the interface, and receives the data (S105) transmitted by the data transmitting apparatus 102.

The data receiving apparatus 103 is a communication apparatus which receives the message from the flow control apparatus 101 controlling an apparatus cooperative flow, and also receives the data from another apparatus connected to the network. The data receiving apparatus 103 receives, from the flow control apparatus 101, the message containing the interface description document pertaining to the interface of the data transmission service executed by the data transmitting apparatus 102. The data receiving apparatus 103 transmits the data request to the data transmitting apparatus 102 on the basis of the interface description document, and receives the data.

A series of operations of the flow control apparatus 101 are described as the flow description document in advance. It is possible to change the process contents of the data transfer by interchanging the contents of the flow description document.

A protocol used for the data request message (S104) and data return message (S106) is not limited to that for the Web service, such as SOAP and HTTP, and may be other protocols. The system is configured to be able to select, as needed, a protocol suitable for data to be transferred, such as FTP or RTP.

SOAP is an abbreviation for Simple Object Access Protocol. HTTP is an abbreviation for Hyper Text Transfer Protocol. FTP is an abbreviation for File Transfer Protocol. RTP is an abbreviation for Real-time Transport Protocol.

According to the first embodiment, an interface description document of an apparatus which transmits data is transmitted to an apparatus which receives the data. This makes it possible to directly transmit/receive, between the apparatuses, data which need not pass through a flow controller.

### Second Embodiment

The second embodiment of the present invention will be described next in detail with reference to the accompanying drawings.

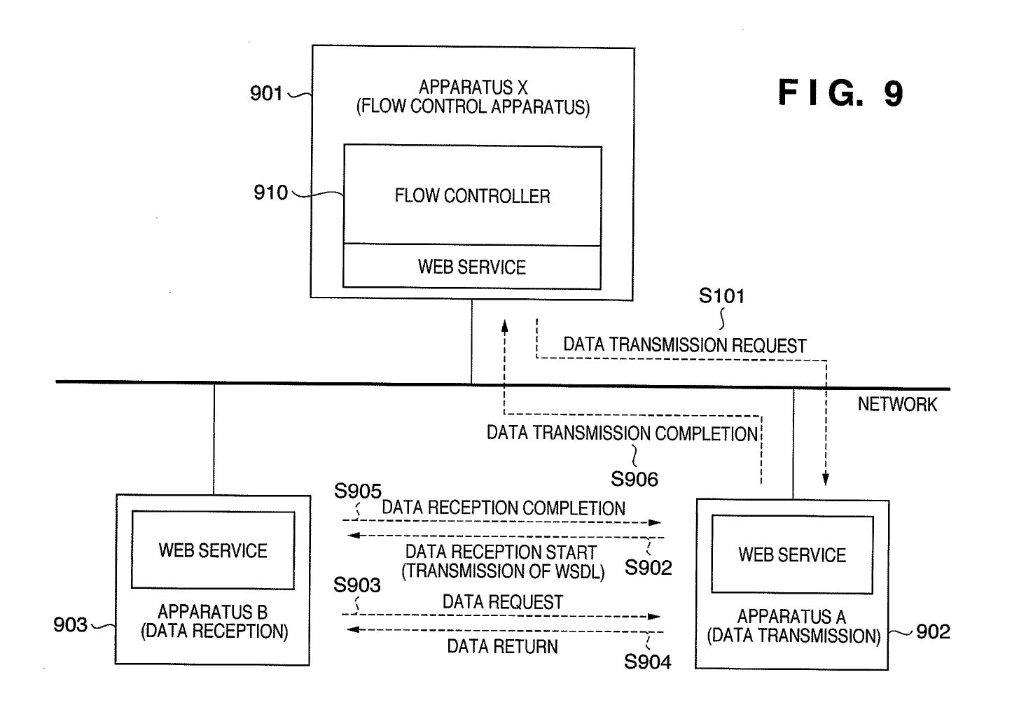

FIG. 9 is a view showing an example of the configuration and operation of a flow control system according to the second embodiment. Referring to FIG. 9, reference numeral 901 denotes apparatus X (a flow control apparatus), which has a function of interpreting a flow description document and controlling, by message exchange of a Web service, other apparatuses each connected to a network. Reference numeral 902 denotes apparatus A (a data transmitting apparatus), which has a function of transmitting data in response to requests from other apparatuses and that of providing, by the Web service, a document (to be referred to as an interface description document hereinafter) that describes an interface for transmitting the data. Reference numeral 903 denotes apparatus B (a data receiving apparatus), which has a function of receiving the interface description document by the Web service and that of interpreting the received interface description document to acquire data. The configuration of the apparatus 901, 902, or 903 in the second embodiment is the same as that shown in FIG. 13.

Each of the above-described apparatuses is connectable to the network, and operates as a user or provider of the Web service. The flow control apparatus 901 includes a flow controller 910. The flow controller 910 interprets the flow description document, and executes control.

The control when the flow control apparatus 901 causes the data transmitting apparatus 902 to directly transmit the data to the data receiving apparatus 903 in the flow control system according to the second embodiment will be described now with reference to FIGS. 6A to 12.

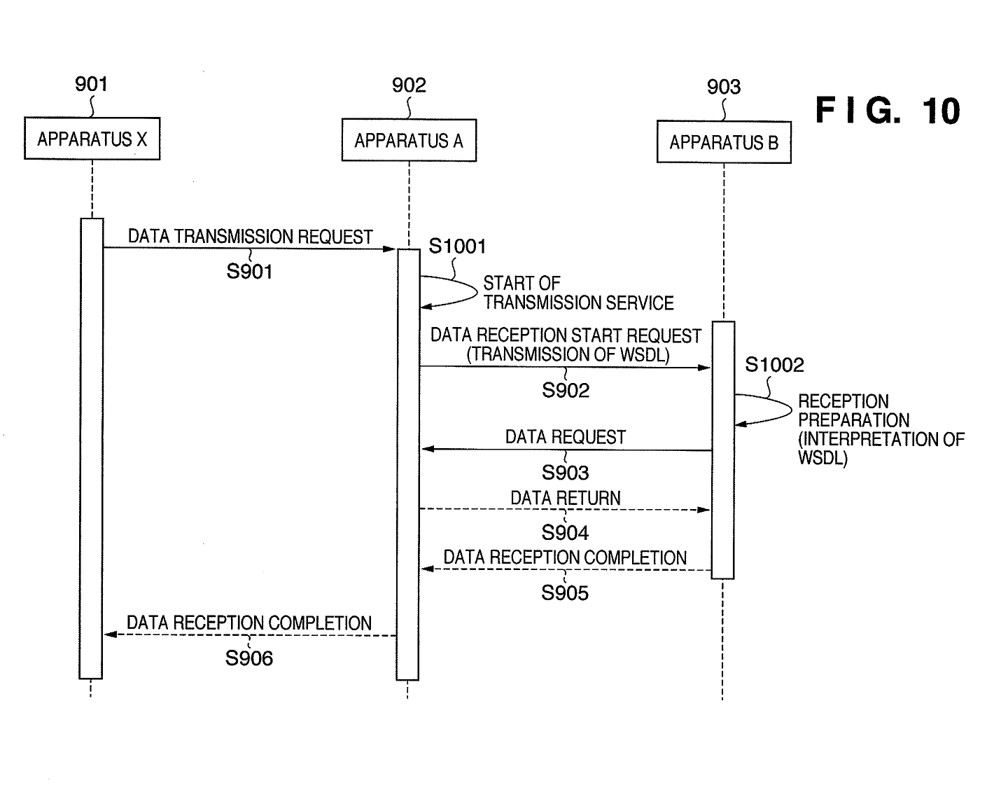

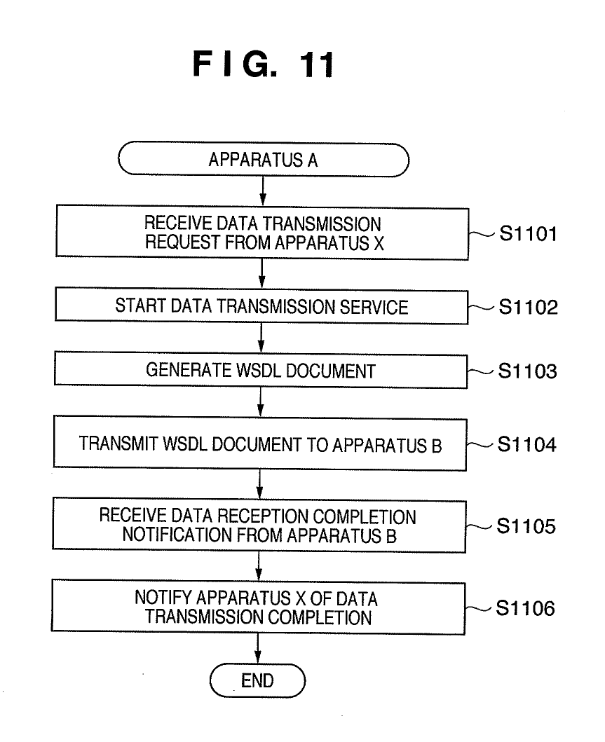

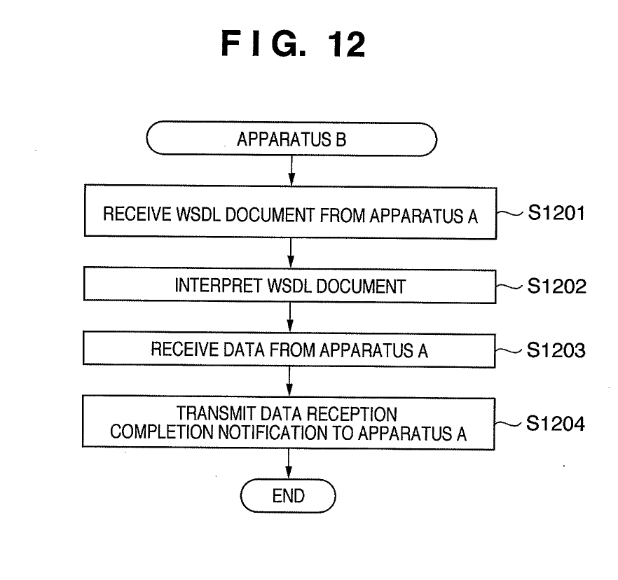

FIG. 10 is a view showing a sequence of messages and data transmitted/received between the apparatuses shown in FIG. 9. FIG. 11 is a flowchart showing the internal operation of the data transmitting apparatus 902 shown in FIG. 9. FIG. 12 is a flowchart showing the internal operation of the data receiving apparatus 103 shown in FIG. 9. The internal operations shown in FIGS. 11 and 12 are merely examples, and the present invention is not limited to them.

The data transmitting apparatus 902 in the second embodiment provides a service represented by a WSDL document in FIGS. 6A and 6B.

The flow control apparatus 901 transmits, to the data transmitting apparatus 902, a data transmission request message (S901) to request preparation for data transmission by the Web service. The data transmission request message (S901) contains a character string (identifier) representing a file (data) to be transmitted by the data transmitting apparatus 902 and an address (identifier) of the data receiving apparatus 903 as the transmission destination of the file. If these identifiers are known to the data transmitting apparatus 902, the data transmission request message (S901) need not contain the identifiers.

Upon reception of the data transmission request message (S901) from the flow control apparatus 901 in step S1101 shown in FIG. 11, the data transmitting apparatus 902 starts a transmission service (S1001) in step S1102. In step S1103, the data transmitting apparatus 902 generates an interface description document (FIGS. 6A and 6B) describing an interface of the started transmission service. In step S1104, the data transmitting apparatus 902 transmits a data reception start message (S902) containing the interface description document to the data receiving apparatus 903.

The data reception start request message (S902) containing the interface description document (FIGS. 6A and 6B) is the same as the data reception start request message (S103) shown in FIGS. 8A and 8B. Thus, an interface description document indicated by the wsdl:operation element within the interface description document specified by the value of an ns1:operation element defines the format of a message transmitted from the data receiving apparatus 903 to the data transmitting apparatus 902. A character string as the value of an ns1:imagefile element of an ns1:finished element represents a file to be transmitted by the data transmitting apparatus 902. In the example shown in FIGS. 8A and 8B, a SOAP message contains the WSDL document by attaching it. As described in the first embodiment, however, the method of containing the WSDL document in the SOAP message is not limited to this.

In step S1201 shown in FIG. 12, the data receiving apparatus 903 recognizes that the received message is the data reception start request message (S902), by reading an ns1:start element within the message received from the data transmitting apparatus 902.

When the data receiving apparatus 903 recognizes that the received message is the data reception start request message (S902), the data receiving apparatus 903 prepares for reception (S1002) in step S1202. In this example, the data receiving apparatus 903 interprets the contents of the ns1:start element, and acquires the value of the ns1:operation element of the ns1:start element. The data receiving apparatus 903 also interprets the interface description document contained in the data reception start request message (S902). Based on the interpretation result, the data receiving apparatus 903 creates a data request message (S903) in the format described in the interface description document indicated by the wsdl:operation element within the interface description document specified by the value of the ns1:operation element. At this time, the data receiving apparatus 903 reads a character string as the value of an ns1:imagename element described in the data reception start request message (S902). The data receiving apparatus 903 sets the character string acquired from the ns1:imagename element into the data request message (S903), and transmits the message to the data transmitting apparatus 902.

That is, the format of the data request message (S903) is defined in the interface description document indicated by the wsdl:operation element within the interface description document specified by the value of the ns1:operation element. The data receiving apparatus 903 sets, at a predetermined position of the message (S903) formed in the format, an identifier of data to be acquired.

In step S1203, the data receiving apparatus 903 receives a data return message (S904) from the data transmitting apparatus 902. In step S1204, the data receiving apparatus 903 returns a data reception completion notification message (S905) to the data transmitting apparatus 902.

In step S1105 shown in FIG. 11, the data transmitting apparatus 902 receives the data reception completion notification message (S905) received from the data receiving apparatus 903. In step S1106, the data transmitting apparatus 902 returns a data transmission completion notification message (S906) to the flow control apparatus 901.

That is, the data transmitting apparatus 902 is a communication apparatus which provides a data transmission service. The data transmitting apparatus 902 executes the first reception step of receiving the first request (S901) from the flow control apparatus 901, and the first transmission step of transmitting information (WSDL) (S902) describing an interface of the service in response to the first request (S901). In this embodiment, the data transmitting apparatus 902 transmits the information (S902) to the data receiving apparatus 903. Furthermore, the data transmitting apparatus 902 executes the second reception step of receiving the second request (S903) from the data receiving apparatus 903.

The data transmitting apparatus 902 executes the second transmission step of transmitting data (S904) by the data transmission service in response to the second request (S903), according to the interface of the service, received from the data receiving apparatus 903. The information describing the interface specifies the format of the second request (S903). The second request in the format contains, at a predetermined position, information specifying data. According to another embodiment, the information specifying the data is contained in the first request (S901) or the information (S902) describing the interface.

The data transmitting apparatus 902 is a communication apparatus which receives the first request (S901) from the flow control apparatus 901 controlling an apparatus cooperative flow, and transmits data in response to the second request (S903) from another apparatus connected to the network. That is, the data transmitting apparatus 902 receives the first request (S901) from the flow control apparatus 901, and transmits the message (S902) containing the interface description document pertaining to the interface of the data transmission service.

The data transmitting apparatus 902 receives the second request (S903) corresponding to the interface description document from the data receiving apparatus 903, and transmits the data (S904). In this embodiment, the data transmitting apparatus 902 transmits the message (S902) to the data receiving apparatus 903. When the data reception by the data receiving apparatus 903 is complete (S905), the data transmitting apparatus 902 notifies the flow control apparatus 901 of the completion (S906). The interface description document specifies the format of the second request (S903). The second request in the format contains, at a predetermined position, information specifying data. According to another embodiment, the information specifying the data is contained in the first request (S901) or the message (S902).

A series of operations of the flow control apparatus 901 are described as the flow description document in advance. It is possible to change the process contents of the data transfer by interchanging the contents of the flow description document.

A protocol used for the data request message (S903) and data return message (S904) is not limited to that for the Web service, such as SOAP and HTTP, and may be other protocols. The system is configured to be able to select, as needed, a protocol suitable for data to be transferred, such as FTP or RTP.

According to the second embodiment, an interface description document of an apparatus which transmits data is transmitted to an apparatus which receives the data. This makes it possible to directly transmit/receive, between the apparatuses, data which need not pass through a flow controller.

### Third Embodiment

The third embodiment of the present invention will be described next in detail with reference to the accompanying drawings. In the third embodiment, a case will be explained, in which the present invention is applied to a system that acquires various data, lays them out on a sheet, and prints them.

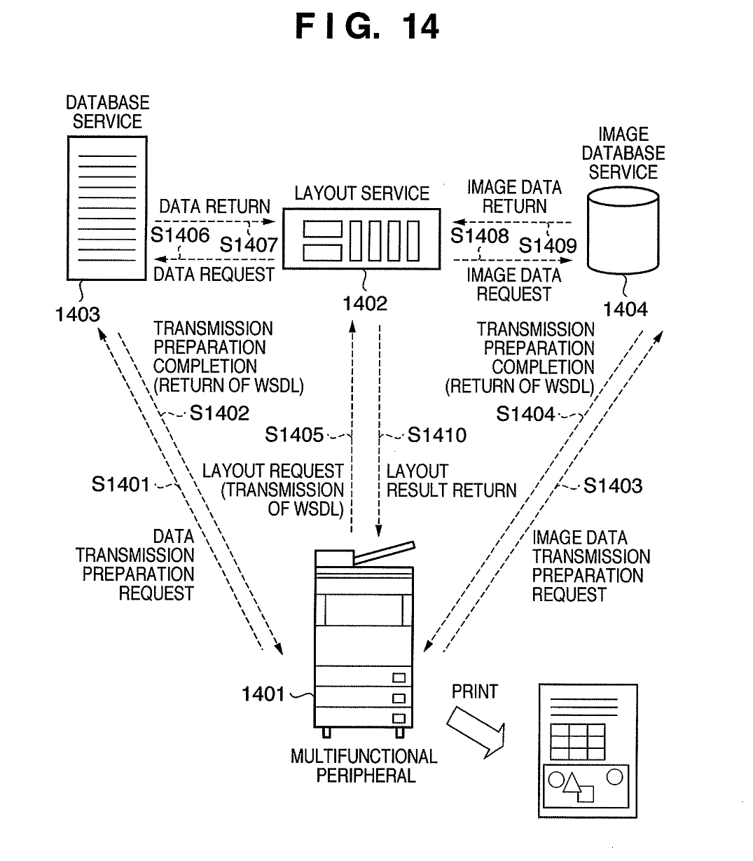

FIG. 14 is a view showing an example of the configuration and operation of a system according to the third embodiment. Referring to FIG. 14, reference numeral 1401 denotes a multifunctional peripheral, which has a flow control function and a function of printing data as a layout result. Reference numeral 1402 denotes a layout service, which has a function of interpreting an interface description document and receiving data, and that of laying out a plurality of received data and outputting the layout result as print data.

Reference numeral 1403 denotes a database service, which has a function of holding various text data and transmitting them to other apparatuses connected with each other via a network, and a function of providing an interface description document for acquiring data. Reference numeral 1404 denotes an image database service, which has a function of holding binary data such as image data and transmitting the data to other apparatuses connected with each other via the network, and a function of providing an interface description document for acquiring the data by other apparatuses.

There are the following correspondences between the apparatuses in the first and third embodiments. The multifunctional peripheral 1401 corresponds to a flow control apparatus 101. Each of the database service 1403 and image database service 1404 corresponds to a data transmitting apparatus 102. The layout service 1402 corresponds to a data receiving apparatus 103. In this embodiment, an overview of the operation of the system will be described. The details of the operation are the same in the first embodiment. It is also possible to apply the sequence in the second embodiment to the configuration in FIG. 14.

In the configuration shown in FIG. 14, the multifunctional peripheral 1401 transmits a data transmission preparation request message (S1401) to the database service 1403 by the Web service. The multifunctional peripheral 1401 receives, from the database service 1403, a data transmission preparation completion notification message (S1402) containing an interface description document for acquiring data to be laid out.

The multifunctional peripheral 1401 transmits an image data transmission preparation request message (S1403) to the image database service 1404. The multifunctional peripheral 1401 receives, from the image database service 1404, an image data transmission preparation completion notification message (S1404) containing an interface description document for acquiring image data to be laid out. The multifunctional peripheral 1401 transmits, to the layout service 1402, a layout request message (S1405) containing the interface description documents received from the database service 1403 and the image database service 1404.

On the other hand, the layout service 1402 interprets the interface description documents transmitted from the multifunctional peripheral 1401, and transmits a data request message (S1406) based on the interpretation result to the database service 1403. The layout service 1402 receives a data return message (S1407) from the database service 1403. The layout service 1402 also transmits, to the image database service 1404, an image data request message (S1408) based on the interpretation result of the interface description documents transmitted from the multifunctional peripheral 1401. Upon reception of an image data return message (S1409) from the image database service 1404, the layout service 1402 lays out the received data and image data, and creates print data.

Upon reception of a layout result return message (S1410) containing the print data created in the layout service 1402, the multifunctional peripheral 1401 prints the print data on a sheet.

The above-described series of operations are executed when the multifunctional peripheral 1401 interprets a flow description document by using a flow control function.

According to the third embodiment, in a system which acquires various data, lays them out on a sheet, and prints it, a layout service directly collects, by bypassing a multifunctional peripheral, the various data to be laid out, thereby avoiding unwanted data transfer.

### Fourth Embodiment

The fourth embodiment of the present invention will be described next in detail with reference to the accompanying drawings. In the fourth embodiment, a case in which the present invention is applied to, for example, a camera connected to a network will be explained.

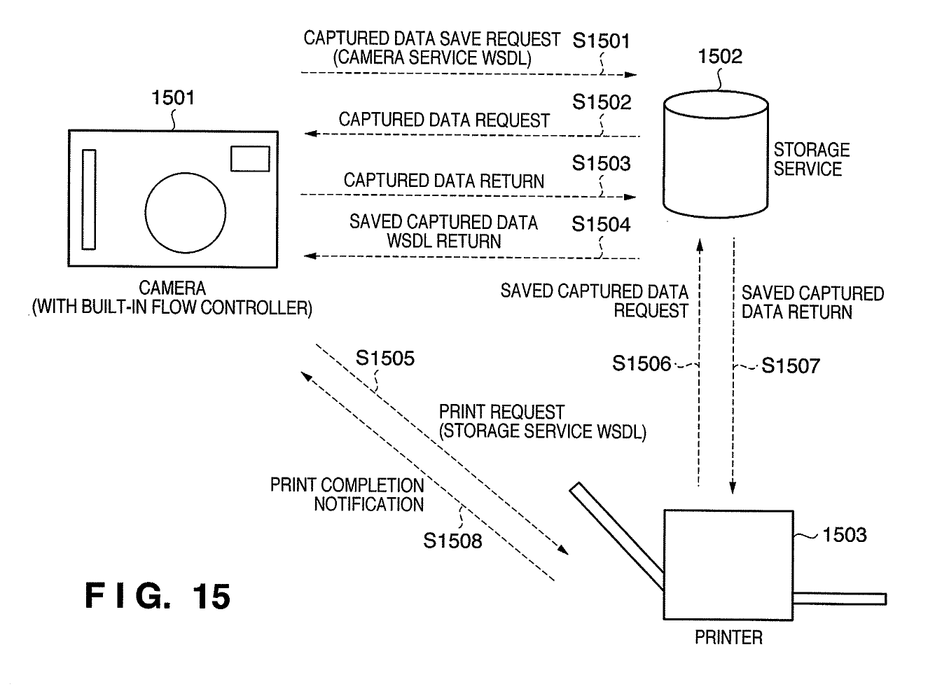

FIG. 15 is a view showing an example of the configuration and operation of a system according to the fourth embodiment. Referring to FIG. 15, reference numeral 1501 denotes a digital camera. The digital camera 1501 is connected to a network, and has a flow control function, data transmission function, and a function of providing an interface description document. Reference numeral 1502 denotes a storage service, which has a function of holding data, of interpreting the interface description document to receive data, and of providing an interface description document to transmit the data. Reference Numeral 1503 denotes a printer, which has a function of interpreting the interface description document to acquire data for print.

Note that there are the following correspondences between the apparatuses in the first and fourth embodiments. The digital camera 1501 corresponds to a flow control apparatus 101. The storage service 1502 corresponds to a data transmitting apparatus 102. The printer 1503 corresponds to a data receiving apparatus 103. In this embodiment, an overview of the operation of the system will be described. The details of the operation are the same in the first embodiment. It is also possible to apply the sequence in the second embodiment to the configuration in FIG. 15.

The digital camera 1501 transmits a captured data save request message (S1501) containing an interface description document of a camera service to the storage service 1502. The interface description document of the camera service is used when the storage service 1502 acquires the captured data from the digital camera 1501, and saves the acquired data.

On the other hand, the storage service 1502 interprets the received interface description document, and transmits a captured data request message (S1502) to the digital camera 1501. The storage service 1502 receives a captured data return message (S1503) from the digital camera 1501, and saves the captured data. After that, the storage service 1502 returns a saved captured data transmission preparation completion message (S1504) containing the interface description document of the storage service to the digital camera 1501.

The interface description document of the storage service is used when the printer 1503 acquires the saved captured data from the storage service 1502, and prints the acquired data.

The digital camera 1501 transmits a print request message (S1505) containing the interface description document of the storage service to the printer 1503.

The printer 1503 interprets the received interface description document, and transmits, to the storage service 1502, a saved captured data request message (S1506) to request the saved data. The printer 1503 receives a saved captured data return message (S1507) from the storage service 1502, and prints the saved captured data on a sheet. After the print process is complete, the printer 1503 returns a print completion notification message (S1508) to the digital camera 1501.

According to the fourth embodiment, when a camera connected to a network causes a printer to print data saved in a storage, the data is directly transmitted from the storage to the printer, thereby avoiding unnecessary data transfer.

The present invention may be applied to a system including a plurality of devices (e.g., a host computer, interface device, reader, and printer) or an apparatus (e.g., a copying machine, or facsimile apparatus) formed by a single device.

The object of the present invention is also achieved when a recording medium which records software program codes for implementing the functions of the above-described embodiments is supplied to a system or apparatus, and the computer (or the CPU or MPU) of the system or apparatus reads out and executes the program codes stored in the recording medium.

In this case, the program codes read out from the computer-readable recording medium implement the functions of the above-described embodiments, and the recording medium which stores the program codes constitutes the present invention.

The recording medium for supplying the program codes includes a flexible disk, hard disk, optical disk, magnetooptical disk, CD-ROM, CD-R, magnetic tape, nonvolatile memory card, and ROM.

The functions of the above-described embodiments are implemented when the computer executes the readout program codes. Also, the functions of the above-described embodiments are implemented when an OS (Operating System) or the like running on the computer performs some or all of actual processes based on the instructions of the program codes.

Furthermore, the present invention includes a case in which, after the program codes read out from the recording medium are written in the memory of a function expansion board inserted into the computer or the memory of a function expansion unit connected to the computer, the CPU of the function expansion board or function expansion unit performs some or all of actual processes based on the instructions of the program codes and thereby implements the functions of the above-described embodiments.

The present invention is not limited to the above embodiments and various changes and modifications can be made without departing from the spirit and scope of the present invention. Therefore, to apprise the public of the scope of the present invention, the following claims are made.

This application claims priority from Japanese Patent Application No. 2006-238171, filed Sep. 1, 2006, and No. 2007-194795, filed Jul. 26, 2007, which are hereby incorporated by reference herein in their entirety.

1. A communication apparatus which provides a data transmission service, comprising:
reception means for receiving a first request from a first apparatus and receiving a second request from a second apparatus; and
transmission means for transmitting information describing an interface of the service in response to the first request received from the first apparatus, and transmitting data by the service in response to the second request, according to the interface of the service, received from the second apparatus.

2. The communication apparatus according to claim 1, wherein said transmission means transmits the information describing the interface of the service to the first apparatus.

3. The communication apparatus according to claim 1, wherein said transmission means transmits the information describing the interface of the service to the second apparatus, and when data reception by the second apparatus is complete, notifies the first apparatus of the completion.

4. A flow control apparatus which controls an apparatus cooperative flow, comprising:
communication means for transmitting, to a first apparatus which provides a data transmission service, a first request to acquire information describing an interface of the service, and receiving the information describing the interface of the service; and
transmission means for transmitting, to a second apparatus, a second request containing the information describing the interface of the service so that the second apparatus receives data using the service provided by the first apparatus.

5. A communication apparatus which receives data from another apparatus, comprising:
reception means for receiving information describing an interface of a data transmission service executed by the other apparatus from a flow control apparatus which controls an apparatus cooperative flow; and
communication means for transmitting a data request to the other apparatus in accordance with the interface of the service, and receiving data transmitted by the other apparatus.

6. A communication method for a communication apparatus which provides a data transmission service, comprising:
a first reception step of receiving a first request from a first apparatus;
a first transmission step of transmitting information describing an interface of the service in response to the first request received from the first apparatus;
a second reception step of receiving a second request from a second apparatus; and
a second transmission step of transmitting data by the service in response to the second request, according to the interface of the service, received from the second apparatus.

7. The communication method for the communication apparatus according to claim 6, wherein the information describing the interface of the service is transmitted to the second apparatus in the first transmission step; and
the second transmission step includes a notification step of, when data reception by the second apparatus is complete, notifying the first apparatus of the completion.

8. A communication method for a flow control apparatus which controls an apparatus cooperative flow, comprising:
a first transmission step of transmitting, to a first apparatus which provides a data transmission service, a first request to acquire information describing an interface of the service;
a reception step of receiving the information describing the interface of the service from the first apparatus; and
a second transmission step of transmitting, to a second apparatus, a second request containing the information describing the interface of the service so that the second apparatus receives data using the service provided by the first apparatus.

9. A communication method for a communication apparatus which receives data from another apparatus, comprising:
a first reception step of receiving information describing an interface of a data transmission service executed by the other apparatus from a flow control apparatus which controls an apparatus cooperative flow;
a transmission step of transmitting a data request to the other apparatus in accordance with the interface of the service; and
a second reception step of receiving data transmitted by the other apparatus.

10. A computer-readable storage medium on which is stored a computer program for causing a computer to execute a communication method for a communication apparatus that provides a data transmission service, comprising:
a first reception step of receiving a first request from a first apparatus;
a first transmission step of transmitting information describing an interface of the service in response to the first request received from the first apparatus;
a second reception step of receiving a second request from a second apparatus; and
a second transmission step of transmitting data by the service in response to the second request, according to the interface of the service, received from the second apparatus.

11. The computer-readable storage medium according to claim 10, wherein the information describing the interface of the service is transmitted to the second apparatus in the first transmission step; and
the second transmission step includes a notification step of, when data reception by the second apparatus is complete, notifying the first apparatus of the completion.

12. A computer-readable storage medium on which is stored a computer program for causing a computer to execute a communication method, the program comprising:
a first transmission step of transmitting, to a first apparatus which provides a data transmission service, a first request to acquire information describing an interface of the service;
a reception step of receiving the information describing the interface of the service from the first apparatus; and
a second transmission step of transmitting, to a second apparatus, a second request containing the information describing the interface of the service so that the second apparatus receives data using the service provided by the first apparatus.

13. A computer-readable storage medium on which is stored a computer program for causing a computer to execute a communication method, the program comprising:
a first reception step of receiving information describing an interface of a data transmission service executed by another apparatus from a flow control apparatus which controls an apparatus cooperative flow;
a transmission step of transmitting a data request to the other apparatus in accordance with the interface of the service; and
a second reception step of receiving data transmitted by the other apparatus.
